(19) United States
(12) Patent Application Publication
(10) Pub. No.: US 2023/0087204 A1
(43) Pub. Date: Mar. 23, 2023

(54) SYSTEMS AND METHODS TO SCREEN A PREDICTIVE MODEL FOR RISKS OF THE PREDICTIVE MODEL

(71) Applicant: TIBCO SOFTWARE INC., Palo Alto, CA (US)

(72) Inventors: Thomas HILL, Tulsa, OK (US); Lawrence DERANY, Waltham, MA (US); Eduardo GALVEZ, Waltham, MA (US); Noora HUSSEINI, London (GB); Mark PALMER, New York, NY (US)

(21) Appl. No.: 17/482,716

(22) Filed: Sep. 23, 2021

(51) Int. Cl. G06Q 10/06

(52) U.S. Cl. CPC G06Q 10/0635

(57) ABSTRACT

Systems and methods to screen a predictive model for risks of the predictive model are provided. The method includes obtaining a predictive model and metadata of the predictive model. The method also includes determining, based on a set of criteria for screening the predictive model, a risk of one or more negative consequences associated with the predictive model. The method further includes providing an analysis of the risk of one or more negative consequences.

### BACKGROUND

The present disclosure relates generally to systems and methods to screen a predictive model for risks of the predictive model.

Predictive models, such as artificial intelligence generated or machine learning generated predictive models, are sometimes used to predict existing or future behaviors or outcomes based on historical or current data associated with such behaviors or outcomes. Predictive models are sometimes used by entities to gauge the interest of potential customers to certain products, hire and retain employees, determine future areas of expansion, and predict other behaviors or outcomes based on certain variable inputs of the predictive models. However, some predictive models may inadvertently offend certain groups of the general population, such as for example potential customers who are seniors living in a specific geographic region. Moreover, other predictive models may inadvertently discriminate against certain groups or be selectively inaccurate for certain groups, and other predictive models may run afoul of laws that protect such groups, such as for example single mothers living in a specific country. The consequences of an entity using such predictive models include loss of potential clientele and income, damages to the entity's reputation, and possibly lawsuits from individuals and governmental entities.

### BRIEF DESCRIPTION OF THE DRAWINGS

Illustrative embodiments of the present invention are described in detail below with reference to the attached drawing figures, which are incorporated by reference herein, and wherein:

FIG. 1 is a network environment for screening a predictive model for risks of the predictive model in accordance with one embodiment.

FIG. 2 is a tree diagram illustrating a process to determine, based on a set of criteria for screening the predictive model, risks of one or more negative consequences associated with the predictive model in accordance with one embodiment.

FIG. 3 is a system diagram of the predictive model screening system of FIG. 1 in accordance with one embodiment.

FIG. 4 is an illustration of an exemplary analysis of negative consequences of a predictive model displayed on a display device, as such as on an electronic device of FIG. 1.

FIG. 5 is a flowchart of a process to screen a predictive model for risks of the predictive model in accordance with one embodiment.

FIG. 6 is a flowchart of another process to continuously screen a predictive model for risks of the predictive model in accordance with one embodiment.

The illustrated figures are only exemplary and are not intended to assert or imply any limitation with regard to the environment, architecture, design, or process in which different embodiments may be implemented.

### DETAILED DESCRIPTION

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments is defined only by the appended claims.

The present disclosure relates to systems and methods to screen a predictive model for risks of the predictive model. A predictive model screening system obtains a predictive model and metadata of the predictive model. As referred to herein, a predictive model includes any model or modeling used to predict existing or future behaviors or outcomes based on historical and/or current data associated with such behaviors or outcomes. In some embodiments, predictive models are generated by data scientists, artificial intelligence, machine learning, or through other combinations of varying degrees of human and machine interactions. Examples of behaviors include, but are not limited to, likelihood that a population, a subgroup of the population (e.g., population belong to a certain ethnic group and living in Duncan, Okla. or another quantifiable subgroup), or an individual would be eligible or qualified for a specific medical procedure or other resource or benefit, would pay back a loan (not default on a loan), would commit fraud, would succeed in a specific educational program, would purchase a product, renew a contract, sell a product, apply for a position, accept an offer, travel to a destination, represent a brand, support an entity, vote for a candidate, be eligible for a resource or benefit, be denied a resource or benefit, and other types of quantifiable human behaviors. Further, as referred to herein, metadata of predictive model include any data associated with the predictive model. In some embodiments, metadata include data related to examination and scrutinizing of predictive model and similar predictive models such as, but not limited to, standard indicators of bias, fairness, and explainability associated with the predictive model, the model complexity associated with the predictive model, the linearity of the predictive model, the degrees of predictor interactions of the predictive model, current and historical ratings (including ratings by individuals and machine ratings) of the predictive model, metadata or similar predictive models, training and testing data of the predictive model and similar models, empirical indicators (including but not limited to acceptability, offensiveness, number of complaints, number of negative comments, ratings by human judges of model desirability, fairness, adequacy, offensiveness, or likely affective responses by targets of the prediction, and other quantifiable empirical indicators) of the predictive model and similar predictive models, and other data related to examination and scrutinizing of the predictive model and similar models.

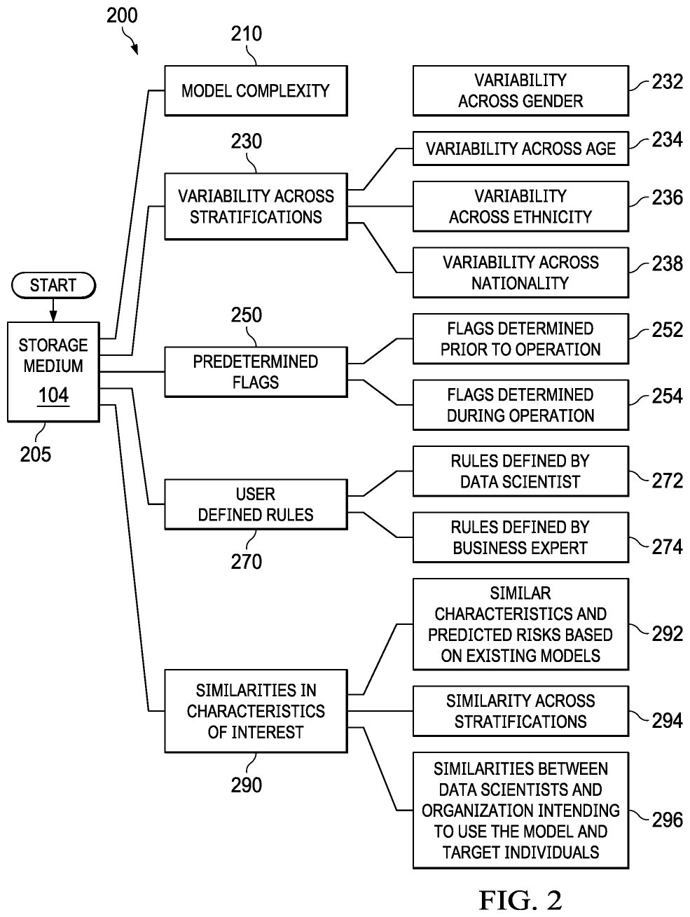

The predictive model screening system determines risks of one or more negative consequences associated with the predictive model based on a set of criteria for screening the predictive model. As referred to herein, a negative consequence is a negative reaction or feedback that a target individual, audience, or a governmental or legislative agency governing the target individual or audience of the predictive model may have or develop due to the application of the predictive model. Examples of negative consequences include, but are not limited to a target individual, a target subgroup, or a target population becoming inadvertently offended, discriminated against, or adversely reacting to the predictive model, including but not limited to, protesting an eligibility for or denial of a service, benefit, specific interest rate on a loan, specific limit on a credit, reimbursement for an insured loss, or refusing to purchase a product, renew a contract, sell a product, apply for a position, accept an offer, travel to a destination, represent a brand, support an entity, vote for a candidate, or reacting in other adverse manners. Examples of criteria for screening the predictive model include, but are not limited to, a model complexity of the predictive model, a variability of the predictive model across a plurality of stratifications (such as age, gender, demographics, income, ethnicity, nationality, and other quantifiable stratifications and their combinations), a degree of similarity with respect to demographics, income, ethnicity, nationality, and other quantifiable stratification of the specific population (team) that created the model or the organization intending to use the model when compared to the population to whom the model is intended to be applied, a degree of similarity with respect to demographics, income, ethnicity, nationality, and other quantifiable stratification of the specific population samples used to create the model when compared to the population to whom the model is intended to be applied, a presence of a predetermined flag associated with the predictive model, user-defined rules associated with the predictive model, and criteria of similar predictive models. As referred to herein, risk of a negative consequence refers to a quantifiable measurement (e.g., 100%, 60%, highly likely, not likely, etc.) of the likelihood of the occurrence of the negative consequence. Additional descriptions of operations performed by the predictive model screening system to determine risks of negative consequences associated with the predictive model are provided in the paragraphs below and are illustrated in at least FIG. 2.

In some embodiments, the predictive model screening system applies all of the applicable criteria to determine risks of negative consequences associated with the predictive model. In some embodiments, the predictive model screening system applies certain criteria based on a weighted system. For example, user-defined rules associated with the predictive model are given a first weight, whereas criteria of similar predictive models are given a second weight that is lower than the first weight and are applied if they do not contradict user-defined rules.

In some embodiments, the metadata of the predictive model are periodically or continuously updated to account for and to predict risks of the one or more negative consequences associated with the predictive model. For example, after the predictive model screening system determines that the predictive model is associated with a greater-than-0 probability to inadvertently offend target audiences of a certain age and ethnicity, and living in a certain geographic region, the predictive model screening system dynamically updates indicators of bias and fairness associated with the predictive model, the propensity-to-offend of the predictive model, and other metadata of the predictive model to reflect the most recently determined risks of the negative consequences. In some embodiments, the predictive model screening system utilizes the metadata or requests another system to utilize the metadata to modify an existing predictive model to reduce the risks of negative consequences associated with the existing predictive model, or to build a new predictive model having reduced risks of the negative consequences.

The predictive model screening system also generates an analysis and predictions of the risks regarding potential of the negative consequences. In some embodiments, the predictive model screening system also generates empirical indicators of the predicted negative consequences, such as, but not limited to, the number of complaints associated with the predictive model, the number of contested or incorrect predictions attributed to the predictive model, the number of negative comments on social media or on other mediums attributed to the predictive model, and other quantifiable empirical indicators of the predicted negative consequences of the use of the predictive model. In one or more of such embodiments, the predictive model screening system includes the generated empirical indicators in the analysis of the negative consequences. In some embodiments, the analysis is provided to an operator of the predictive model screening system, or a data scientist associated with the predictive model for additional assessment. In one or more of such embodiments, the predictive model screening system generates one or more texts, graphs, charts, images, audios, videos, and multimedia content that describe or illustrate the analysis of the negative consequences, and provides the generated texts, graphs, charts, images, audios, videos, and multimedia content for display on a display screen of an operator or data scientist. In one or more of such embodiments, the predictive model screening system also provides recommendations and suggestions on how to interpret the generated analysis as well as how to improve the predictive model to reduce or eliminate some of the risks of the negative consequences. In some embodiments, the predictive model screening system dynamically provides the analysis to an electronic system that is running the predictive model.

In some embodiments, the predictive model screening system periodically, continuously, or dynamically monitors the predictive model for a threshold period of time (e.g., for a day, a week, a month, or another period of time) or iterations (e.g., two times, ten times, 100 times, or another threshold period of iterations) to monitor the risks of the negative consequences and changes in the risks of the negative consequences associated with the predictive model. In some embodiments, the predictive model screening system determines whether a risk of the negative consequences exceeds a predetermined threshold (e.g., greater than 20% likely, greater than 50% likely, highly likely, or another quantifiable threshold). In one or more of such embodiments, the predictive model screening system provides a suggestion to modify the predictive model, such as reducing the number of variables, reducing the complexity of the predictive model, using data scientists that have more similarities with the target population, and other quantifiable suggestions to modify the predictive model. In one or more of such embodiments, the predictive model screen system provides an indication that the risk exceeds the predetermined threshold and suggestions to modify the predictive model for display on a display screen of the data scientist.

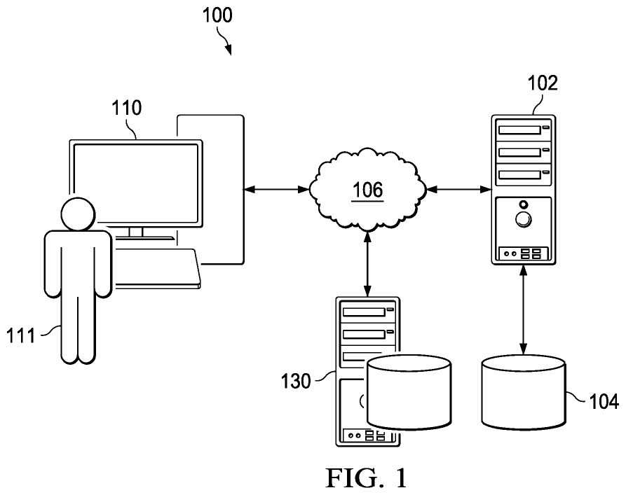

In one or more of such embodiments, the predictive model screening system determines an update to the metadata of the predictive model based on the risk of the negative consequences, and updates the metadata of the predictive model to account for the risk of the negative consequences. Additional descriptions of the predictive model screening system and operations performed by the predictive model screening system are provided in the paragraphs below and are illustrated in at least FIGS. 1-6.

FIG. 1 is a network environment 100 for screening a predictive model for risks of the predictive model in accordance with one embodiment. Network environment 100 includes a predictive model screening system 102 that is communicatively connected to an electronic device 110 that is operated by a data scientist 111, and a predictive model storage system 130 via a network 106.

Predictive model screening system 102 may be formed from one or more work management stations, server systems, desktop computers, laptop computers, tablet computers, smartphones, smart watches, virtual reality systems, augmented reality systems, as well as similar electronic devices having one or more processors operable to obtain a predictive model and metadata of the predictive model, a predictive model for risks of the predictive model, determine and predict, based on a set of criteria for screening the predictive model, risks of one or more negative consequences associated with the predictive model, and generate an analysis of the one or more predicted negative consequences. Additional descriptions of operations performed by predictive model screening system 102 are provided herein and are illustrated in at least FIGS. 2-6. Predictive model screening system 102 includes or is communicatively connected to a storage medium, such as storage medium 104. Storage medium 104 stores instructions, which when executed by one or more processors of predictive model screening system 102, cause the processors to perform the foregoing operations as well as other operations described herein. Storage medium 104, in addition to storing executable instructions, also stores metadata of predictive models and data indicative of criteria for screening predictive models, such as criteria illustrated in FIG. 2 and described herein. Storage medium 104 also stores information provided by electronic device 110, predictive model storage system 130, and by other predictive model storage systems, such as predictive models, data indicative of prior screenings of the predictive models, and metadata of the predictive models. Storage medium 104 may be formed from data storage components such as, but not limited to, read-only memory (ROM), random access memory (RAM), flash memory, magnetic hard drives, solid state hard drives, CD-ROM drives, DVD drives, floppy disk drives, as well as other types of data storage components and devices. In some embodiments, storage medium 104 includes multiple data storage devices. In further embodiments, the multiple data storage devices may be physically stored at different locations. In one of such embodiments, the data storage devices are components of a server station, such as a cloud server. In another one of such embodiments, the data storage devices are components of predictive model screening system 102.

Predictive model screening system 102 is also communicatively connected to predictive model storage system 130. Predictive model storage system 130 includes any systems or devices configured to provide one or more predictive models to predictive modeling screening system 102. In some embodiments, predictive model storage system 130 is also configured to generate, analyze, and update predictive models. In the depicted embodiment, predictive model storage system 130 provides predictive model screening system 102 with up-to-date predictive models together with a request to screen the predictive models. In some embodiments predictive model storage system 130 also provides predictive model screening system 102 with one or more criteria applied by predictive model screening system 102 to screen predictive models for risks of negative consequences associated with the predictive models.

In the embodiment of FIG. 1, predictive model screening system 102, after obtaining a predictive model from predictive model storage system 130, accesses storage medium 104 and/or predictive model storage system 130 to obtain criteria for screening the predictive model. Predictive model screening system 102 determines one or more risk factors associated with the probability for negative consequences to be associated with the predictive model based on a set of criteria for screening the predictive model, such as the criteria illustrated in FIG. 2 and described herein. In the depicted embodiment, predictive model screening system 102 generates an analysis of the risks of the one or more negative consequences, and provides the analysis for display on a display screen of electronic device 110.

Electronic device 110 includes any devices that are operable to provide an analysis of negative consequences of a predictive model for display. In some embodiments, electronic device 110 is also operable to receive instructions from a user such as data scientist 111 to monitor, analyze, and update one or more parameters of the predictive model based on an analysis provided by predictive model screening system 102. In the embodiment of FIG. 1, electronic device 110 is a desktop computer. Additional examples of electronic devices include, but are not limited to, laptop computers, tablet computers, smartphones, smart watches, virtual reality systems, augmented reality systems, as well as similar electronic devices having a processor operable to provide an analysis of negative consequences of a predictive model for display.

In some embodiments, where data scientist 111 makes one or more adjustments to the predictive model or where two or more models are compared based on the analysis provided by predictive model screening system 102, electronic device 110 provides an updated predictive model to predictive model screening system 102. Predictive model screening system 102, in response to receiving the updated predictive model, performs the operations described herein to determine and predict the risk, based on the criteria for screening the updated predictive model, of negative consequences or changes in the negative consequences associated with the updated predictive model. Predictive model screen system 102 then generates an updated analysis of the updated predictive model together with changes to the negative consequences, and provides the updated analysis for display on electronic device 110. In some embodiments, predictive model screening system 102 also determines, based on changes to the negative consequences, an update to the metadata of the predictive model, and updates the existing metadata of the predictive model to account for (predict) changes to the negative consequences. In one or more of such embodiments, predictive model screening system 102 also provides electronic device 110 and predictive model storage system 130 with changes to the metadata.

In some embodiments, predictive model screening system 102 is configured to continuously or dynamically screen a predictive model or multiple iterations of the predictive model (where each iteration contains one or more updates to the existing predictive model) over a period of time. For example, predictive model screening system 102 is configured to screen a predictive model for a threshold number of times (e.g., ten times, 100 times, 1,000 times, or another number of times) over a period of one month (or another period of time), and determine, based on the criteria for screening the predictive model, changes to negative consequences, such as improvements, newly developed negative consequences, or other changes. In one or more of such embodiments, predictive model screening system 102 periodically or dynamically provides electronic device 110 and predictive model storage system 130 with data indicative of changes to the one or more predicted negative consequences.

Network 106 can include, for example, any one or more of a cellular network, a satellite network, a personal area network (PAN), a local area network (LAN), a wide area network (WAN), a broadband network (BBN), a RFID network, a Bluetooth network, a device-to-device network, the Internet, and the like. Further, network 106 can include, but is not limited to, any one or more of the following network topologies, including a bus network, a star network, a ring network, a mesh network, a star-bus network, a tree or hierarchical network, or similar network architecture. Network 106 may be implemented using different protocols of the internet protocol suite such as TCP/IP. Network 106 includes one or more interfaces for data transfer. In some embodiments, network 106 includes a wired or wireless networking device (not shown) operable to facilitate one or more types of wired and wireless communication between predictive model screening system 102, electronic device 110, predictive model storage system 130, as well as other electronic devices (not shown) and systems (not shown) communicatively connected to network 106. Examples of the networking device include, but are not limited to, wired and wireless routers, wired and wireless modems, access points, as well as other types of suitable networking devices described herein. Examples of wired and wireless communication include Ethernet, WiFi, Cellular, LTE, GPS, Bluetooth, and RFID, as well as other types of communication modes described herein.

Although FIG. 1 illustrates electronic device 110 operated by data scientist 111, in some embodiments, predictive model screening system 102 concurrently or periodically receives multiple requests to screen different predictive models from multiple electronic devices (not shown) operated by a different number of users. In some embodiments, predictive model screening system 102 is configured to simultaneously perform operations described herein to determine, based on an applicable set of criteria for screening a corresponding predictive model, predicted risk of negative consequences associated with the corresponding predictive model. In some embodiments, where predictive model screening system 102 is only communicating with predictive model storage system 130, predictive model screening system 102 is also configured to provide an analysis of negative consequences associated with a predictive model to predictive model storage system 130. In one or more of such embodiments, where predictive model storage system 130 is configured to dynamically adjust the predictive model based on the analysis provided by predictive model screening system 102, predictive model screening system 102 is also operable to perform operations described herein to continuously or dynamically screen an updated predictive model, and provide predictive model storage system 130 with data indicative of changes to the predicted negative consequences as a result of updates made to the predictive model.

FIG. 2 is a tree diagram illustrating a process 200 to determine, based on a set of criteria for screening a predictive model, risks of one or more negative consequences associated with the predictive model in accordance with one embodiment. Although operations in the process 200 are shown in a particular sequence, certain operations may be performed in different sequences or at the same time where feasible. Further, in some embodiments, different combinations of some or all of the steps of the process 200 are performed to determine the risks of the one or more negative consequences associated with the predictive model.

At block 205, predictive model screening system 102, upon obtaining a predictive model, accesses storage medium 104 to obtain instructions that define the set of criteria for screening the predictive model. In the depicted embodiment, instructions that define the set of criteria for screening the predictive model are categorized into several sub-criteria, including the model complexity of the predictive model, the variability of the predictive model predictions in a historical data sample across multiple stratifications and combinations of stratifications, the variability of predictive model accuracy in a historical data sample across multiple stratifications and combinations of stratifications, the presence of predetermined flags associate with the predictive model, user defined rules for screening the predictive model, and criteria and prediction models of negative consequences derived from similar predictive models.

At block 210, predictive model screening system 102 accesses a first sub-criteria for screening the predictive model that defines how to determine risks of negative consequences associated with the predictive model based on the model complexity of the predictive model. More particularly, and all other factors being equal, a predictive model becomes more difficult to implement, less explainable, less accurate, and more prone to being associated with risks of negative consequences as the complexity of the predictive model increases from a linear model of single factors to a higher order model involving interactions between factors, or nonlinear models of single factors and their interactions. As such, all other factors being equal, predictive model screening system 102 attributes a first predictive model having a first order of complexity and a first accuracy with more risk for negative consequences than a second predictive model having a second order of complexity that is lower than the first order of complexity and the same accuracy.

At block 230, predictive model screening system 102 accesses a second sub-criteria for screening the predictive model that defines how to determine risks of negative consequences associated with the predictive model based on variability of the predictive model across multiple stratifications with respect to the average predicted values and the accuracy of the predicted values computed for the predictive model. In some embodiments, predictive model screening system 102 implements sets of different stratifications with respect to some or all available inputs, by converting continuous predictors into multiple categories, and then cross-tabulating some or all categorical inputs up to a user-defined degree (2-way tables, 3-way tables, k-way tables). In one or more of such embodiments, where information and sufficient numbers of observations are available, these stratifications are performed on the population of data scientists (e.g., the data scientists, or the entire organization deploying the model) as well as training, testing, and any available recent application samples of observations. In one or more of such embodiments, tabulations include simple n's (the number of observations in each cell of the respective cross-tabulations) and model accuracy estimates. In one or more of such embodiments, predictive model screening system 102 assesses the similarity of the distributions of data scientists or other stakeholders and decision makers in the organization that created and intends to use the model to evaluate evidence of dissimilarity and thus potential bias due to organizations building prediction models for demographically different targets (e.g., biological males building models for biological females).

In one or more of such embodiments, predictive model screening system 102 assesses sparse classes or under/overrepresentations of certain strata across all strata by computing the variability of n's (the numbers-of-observations) across strata, based on training, testing, or recent application samples. Moreover, predictive model screening system 102 determines that there is an increased risk of under or over-representing certain strata in the target population if the variability is relatively large compared to historical comparisons to other models in the model repository, is greater than a threshold value. In one or more of such embodiments, predictive model screening system 102 assesses differential accuracy across the strata in the training, testing, or recent application samples, where a greater variability of accuracy across the strata is associated with a greater risk that prediction model is inaccurate with respect to certain groups of targets, and hence such model has a greater likelihood to be unfair, offend, cause pushback, draw regulatory scrutiny, and/or cause reputational damage.

The depicted embodiment illustrates four different example criteria of the second sub-criteria for screening the predictive model based on exemplary stratifications including gender, age, ethnicity, and nationality. More particularly, at blocks 232, 234, 236, and 238, predictive model screening system 102 determines risks of negative consequences associated with the predictive model based on variability across gender, age, ethnicity, nationality, and variability across the combinations of gender, age, ethnicity, and nationality, respectively. For example, at block 232, predictive model screening system 102 determines that the variability of an impact of the predictive model on different genders of a target population is greater than an acceptable threshold, and determines the presence of gender bias against a specific gender. Similarly, at block 234, predictive model screening system 102 determines that the variability of an impact of the predictive model on different age groups of a target population is greater than an acceptable threshold, and determines the presence of unintentional discrimination against certain age groups.

At block 250, predictive model screening system 102 accesses a third sub-criteria for screening the predictive model that defines how to determine risks of negative consequences associated with the predictive model based on predetermined flags associated with the predictive model. In some embodiments, predictive model screening system 102 flags certain variables that are known a-priori to be associated with risk-to-offend, cause pushback, reputational damage, or are attributed to one or more risks of negative consequences. The depicted embodiment illustrates two different criteria of the third sub-criteria for screening the predictive model based on flags determined by predictive model screening system 102 prior to process 200, and flags determined by predictive model screening system 102 during process 200. More particularly, at block 252, predictive model screening system 102 determines risks of negative consequences associated with the predictive model based on flags determined by predictive model screening system 102 prior to process 200. Similarly, at block 254, predictive model screening system 102 determines risks of negative consequences associated with the predictive model based on flags determined by predictive model screening system 102 during process 200. In some embodiments, predictive model screening system 102 not only screens for variables that are attributed to risks of negative consequences, but also periodically or dynamically screens for and monitors relationships of those variables with respect to accuracy, and average prediction (e.g., average or median predicted credit-default-risk) to gauge and monitor risks of the variables.

At block 270, predictive model screening system 102 accesses a fourth sub-criteria for screening the predictive model that defines how to determine risks of negative consequences associated with the predictive model based on user defined rules. In that regard, predictive model screening system 102 is configured to incorporate policies, rules, guidance, requests, procedures, and the like (collectively “rules”) of data scientists and individuals responsible for creating, testing, and implementing the predictive model, data scientists and individuals operating predictive model screening system 102, and other individuals associated with the predictive model (collectively “user defined rules”) to monitor and screen for risks of negative consequences associated with the predictive model. The depicted embodiment illustrates two different criteria of the fourth sub-criteria for screening the predictive model based on rules defined by data scientists and individuals responsible for creating, testing, and implementing the predictive model, and based on data scientists and individuals operating predictive model screening system 102. More particularly, at block 272, predictive model screening system 102 applies rules defined by data scientists and individuals responsible for creating, testing, and implementing the predictive model to determine risks of negative consequences associated with the predictive model. Similarly, at block 274, predictive model screening system 102 applies rules defined by data scientists and individuals operating predictive model screening system 102 to determines risks of negative consequences associated with the predictive model. In some embodiments, some organizations that utilize the predictive model develop experience with specific aspects of the predictive model that improves or worsens certain risks of negative consequences, and develop rules that reduce or eliminate the impact or likelihood of certain negative consequences. In one or more of such embodiments, predictive model screening system 102, upon receipt of post implementation rules, also applies the post implementation rules to reduce or eliminate certain risks of negative consequences associated with the predictive model.

At block 290, predictive model screening system 102 accesses a fifth sub-criteria for screening the predictive model that defines how to determine risks of negative consequences associated with the predictive model based on similarities in one or more characteristics of interest. Examples of characteristics of interest include characteristics of existing predictive models (e.g., number of variables, complexity, and other quantifiable characteristics that are shared with or similar to characteristics of existing predictive models), similarities across stratifications (such as gender, age, ethnicity, nationality, and other quantifiable stratifications), similarities between individuals who built the predictive model and the target individuals (individuals the model is developed for), and other quantifiable characteristics. The depicted embodiment illustrates three different criteria of the fifth sub-criteria for screening the predictive model based on similar characteristics of existing models, similarities across stratifications and their combinations, and similarity between data scientists or the organization intending to use the prediction model compared to the target individuals. More particularly, at block 292, predictive model screening system 102 determines the risks of negative consequences associated with the predictive model based on characteristics and predicted risks based on existing predictive models. For example, predictive model screening system 102 determines the risks of negative consequences associated with a predictive model based on known negative consequences associated with an existing predictive model that shares the same number of variables, are developed by the same group of data scientists, and target the same group of individuals. In some embodiments, where predictive model screening system 102 has access to similar predictive models, predictive model screening system 102 also incorporates certain metadata of similar predictive models, and screens the predictive model for risks of negative consequences that exist in similar predictive models. As referred to herein, a similar predictive model is another predictive model that utilizes similar or identical inputs as the predictive model, another predictive model that targets similar or identical individuals as the predictive model, another predictive models that has an accuracy that is within a threshold of the accuracy of the predictive model, or shares one or more similar characteristics as the predictive model.

Similarly, at block 294, predictive model screening system 102 determines the risks of negative consequences associated with the predictive model based on similarities across different stratifications, such as gender, age, ethnicity, nationality, and other quantifiable stratifications and their combinations. Further, at block 296, predictive model screening system 102 determines the risks of negative consequences associated with the predictive model based on the level of similarity between one or more data scientists and the organization intending to use the model compared to the target individuals. For example, predictive model screening system 102 determines that the risks of negative consequences is a first value where the data scientists and the target individuals live in the same country, speak the same primary language, and have similar education backgrounds, whereas the predictive model screen system determines that the risks of negative consequences is a second value that is higher than the first value where the data scientists and the target individuals live in different countries, speak different languages, and have different education backgrounds.

In certain embodiments, predictive model screening system 102 applies a weighted system to different criteria of the set of criteria for screening the predictive model. For example, rules defined by a data analyst operating predictive model screening system 102 are given a first weight, whereas rules associated with a similar predictive model are applied a second weight that is less than the first weight, or is not applied if the rules associated with the similar predictive model contradict rules defined by the data analyst operating predictive model screening system 102. Further, predictive model screening system 102 is operable to execute the instructions described in the foregoing paragraph to simultaneously screen multiple predictive models for risks of the respective predictive models.

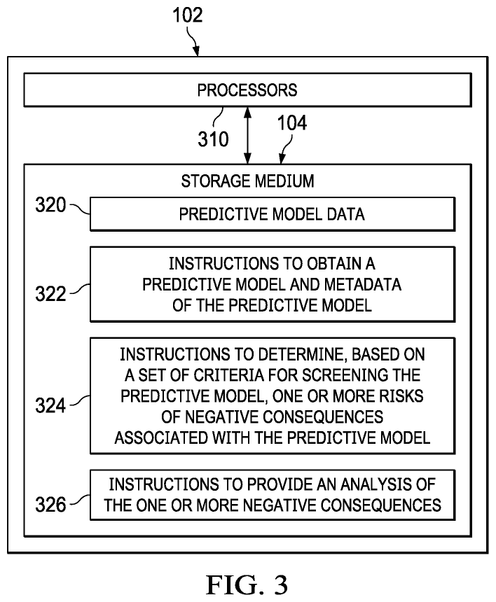

FIG. 3 is a system diagram of predictive model screening system 102 of FIG. 1 in accordance with one embodiment. Predictive model screening system 102 includes or is communicatively connected to storage medium 104 and processors 310. Predictive models, metadata of the predictive models, and other data associated with the predictive models (collectively “predictive model data”) are stored at location 320 of storage medium 104. Instructions to obtain a predictive model and metadata of the predictive model are stored at location 322. Further, instructions to determine, based on a set of criteria for screening the predictive model, risks of one or more negative consequences associated with the predictive model are stored at location 324. Further, instructions to provide an analysis of the risks of one or more negative consequences are stored at location 326. Further, instructions to perform operations described herein and shown in at least FIGS. 2, 5, and 6 are also stored in storage medium 104.

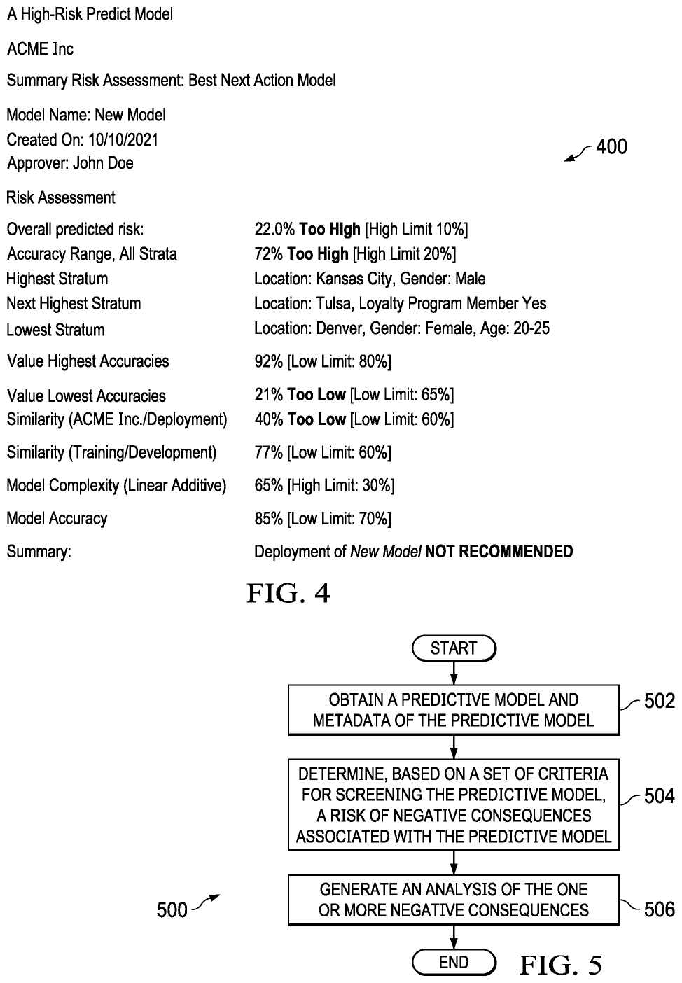

FIG. 4 is an illustration of an exemplary analysis 400 of risks of negative consequences of a predictive model displayed on a display device, such as on a display device electronic device 110 of FIG. 1. In the embodiment of FIG. 4, analysis 400 includes a summary describing the risk assessment of a predictive model screened by predictive model screening system 102. As shown in FIG. 4, several variables, including the overall predicted risk, the accuracy range, and the model complexity are too high and not within acceptable ranges of the corresponding variables. In some embodiments, certain texts are highlighted, bolded, presented in different colors, or emphasized to help a data analyst reviewing the analysis to assess predicted negative consequences associated with the predictive model. In some embodiments, the analysis includes graphical content such as bars, graphs, and charts, audio content, video content, and multimedia content to help the data analyst reviewing the analysis to assess risks of negative consequences associated with the predictive model.

FIG. 5 is a flow chart illustrating a process 500 to screen a predictive model for risks of the predictive model in accordance with one embodiment. Although the operations in process 500 are shown in a particular sequence, certain operations may be performed in different sequences or at the same time where feasible. Further, although process 500 is described to be performed by processors of predictive model screening system 102 of FIG. 1, it is understood that processors of other predictive model screening systems are also operable to perform process 500.

At block 502, a predictive model screening system, such as predictive model screening system 102 of FIG. 1 obtains a predictive model and metadata of the predictive model. FIG. 1, for example, illustrates predictive model screening system 102 initially obtaining predictive model and metadata of the predictive model from predictive model storage system 130. In some embodiments, predictive model screening system 102 also obtains the predictive model and metadata of the predictive model from electronic device 110. At block 504, the predictive model screening system determines, based on a set of criteria for screening the predictive model, one or more risks of negative consequences associated with the predictive model. FIG. 2, for example, illustrates a tree diagram illustrating process 200 to determine, based on a set of criteria for screening the predictive model, one or more risks of negative consequences associated with the predictive model. In some embodiments, the predictive model screening system also determines one or more empirical indicators of the risks of negative consequences, such as the number of negative feedbacks, the number of negative complaints, the number of media reporting one or more negative feedbacks, and other quantifiable empirical indicators. In some embodiments, the predictive model screening system also predicts risks of one or more negative consequences based on predictive models built from the metadata of similar models. In some embodiments, the predictive model screening system also periodically or dynamically updates metadata of the predictive model to account for the determined and predicted negative consequences.

At block 506, the predictive model screening system generates an analysis of the risks of one or more negative consequences. FIG. 4, for example, illustrates an exemplary analysis 400 generated by predictive model screening system 102. As shown in FIG. 4, analysis 400 provides a summary of certain metrics of the predictive model, whether the metrics are within acceptable thresholds, and whether the predictive model is recommended. In some embodiments, where the predictive model screening system generated empirical indicators of the risks of negative consequences, the predictive model screening system also includes the empirical indicators in the generated analysis.

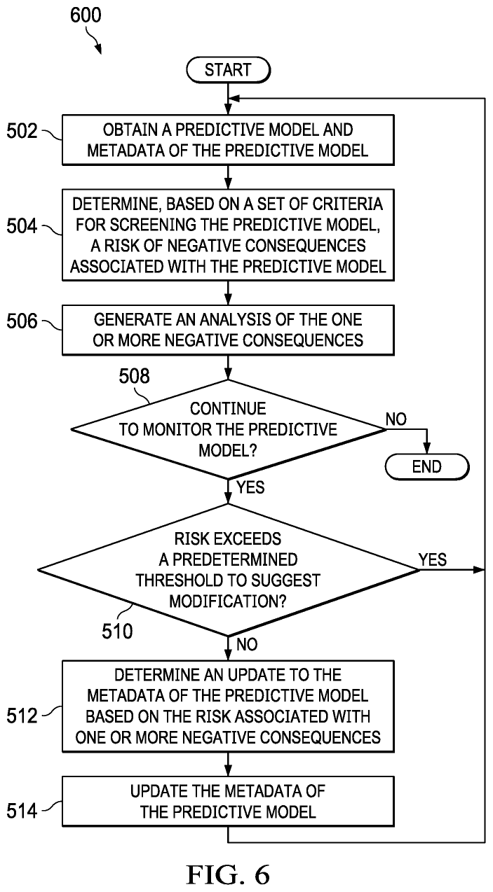

FIG. 6 is a flowchart of another process 600 to continuously screen a predictive model for risks of the predictive model in accordance with one embodiment. Although the operations in process 600 are shown in a particular sequence, certain operations may be performed in different sequences or at the same time where feasible. Further, although process 600 is described to be performed by processors of predictive model screening system 102 of FIG. 1, it is understood that processors of other predictive model screening systems are also operable to perform process 600.

Operations performed at blocks 502, 504, and 506 are described in the paragraphs herein. After block 506, the predictive model screening system proceeds to block 508 to determine whether to continue to monitor the predictive model, such as for a threshold number of iterations (such as two, five, ten, 100, or other threshold number of iterations), or for a threshold period of time (such as ten minutes, one hour, one day, one week, or another threshold period of time). The process ends if the predictive model screening system determines not to continue to monitor the predictive model. Alternatively, the process proceeds to block 510, and the predictive model screening system determines whether risk of the negative consequences exceeds a predetermined threshold (such as one of the thresholds illustrated in FIG. 4 or another threshold value) to suggest a modification to the predictive model.

At block 510, in response to a determination that the risk exceeds a predetermined threshold to suggest a modification, the predictive model screening system provides one or more suggested modifications (such as reducing the number of maximum variables, reducing the complexity of the predictive model, reducing one or more variations across stratifications, or another quantifiable modification) to revise or rebuild the predictive model, and the process proceeds to block 502. Alternatively, the process proceeds to block 512 in a response to a determination that the risk does not exceed the predetermined threshold to suggest a modification. At block 512, the predictive model screening system determines an update to the metadata of the predictive model based on risks of the negative consequences to accurately reflect such changes. The process then proceeds to block 514, where the predictive model screening system updates the metadata of the predictive model. In some embodiments, the predictive model screening system also dynamically generates an updated analysis of the predictive model, and provides the updated analysis to the data analyst. In some embodiments, the predictive model screening system also provides the updated metadata to a data analyst responsible for implementing the predictive model, such as data analyst 111 of FIG. 1. The predictive model screening system performs the process illustrated in blocks 504, 506, 508, 510, 512, and/or 514 whenever a policy or established procedure deems it necessary to screen a prediction model for risk of negative consequences prior to the use (deployment) of the model, or periodically, or continuously to provide up-to-date analysis of the predictive model, which in turn may be used by the data analyst to make consistent real-time or near real-time improvements on the predictive model.

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. For instance, although the flowcharts depict a serial process, some of the steps/processes may be performed in parallel or out of sequence, or combined into a single step/process. The scope of the claims is intended to broadly cover the disclosed embodiments and any such modification. Further, the following clauses represent additional embodiments of the disclosure and should be considered within the scope of the disclosure.

Clause 1, a computer-implemented method to screen a predictive model for risks of the predictive model, comprising: obtaining a predictive model and metadata of the predictive model; determining, based on a set of criteria for screening the predictive model, a risk of one or more negative consequences associated with the predictive model; and generating an analysis of the risk of the one or more negative consequences.

Clause 2, the computer-implemented method of clause 1, wherein a criterion of the set of criteria is a model complexity of the predictive model, and wherein determining, based on the set of criteria for screening the metadata comprises determining, based on the model complexity of the predictive model, the risk of the one or more negative consequences.

Clause 3, the computer-implemented method of clauses 1 or 2, wherein a criterion of the set of criteria is a variability of the predictive model across a plurality of stratifications, and wherein determining, based on the set of criteria for screening the metadata comprises determining, based on the variability of the predictive model across the plurality of stratifications, the risk of the one or more negative consequences.

Clause 4, the computer-implemented method of any of clauses 1-3, wherein a criterion of the set of criteria is a presence of a predetermined flag associated with the predictive model, and wherein determining, based on the set of criteria for screening the metadata comprises determining, based on the predetermined flag associated with the predictive model, the risk of the one or more negative consequences.

Clause 5, the computer-implemented method of any of clauses 1-4, wherein a criterion of the set of criteria is a user-defined rule associated with the predictive model, and wherein determining, based on the set of criteria for screening the metadata comprises determining, based on the user-defined rule associated with the predictive model, the risk of the one or more negative consequences.

Clause 6, the computer-implemented method of any of clauses 1-5, wherein a criterion of the set of criteria is a similarity in a characteristic of interest, and wherein determining, based on the set of criteria for screening the metadata comprises determining, based on the similarity in the characteristic of interest, the risk of the one or more negative consequences.

Clause 7, the computer-implemented method of any of clauses 1-6, further comprising updating the metadata of the predictive model to account for the risk of the one or more negative consequences.

Clause 8, the computer-implemented method of any of clauses 1-7, further comprising generating one or more empirical indicators of the risk of the one or more negative consequences, wherein the analysis comprises the one or more empirical indicators.

Clause 9, the computer-implemented method of clause 8, further comprising determining a number of negative feedbacks of the predictive model, wherein the number of negative feedbacks of the predictive model is an empirical indicator of the one or more empirical indicators.

Clause 10, the computer-implemented method of any of clauses 1-9, further comprising providing the analysis of the risk of the one or more negative consequences for display on a display screen of an electronic device.

Clause 11, the computer-implemented method of any of clauses 1-10, further comprising: determining whether the risk of the one or more negative consequences is greater than a threshold to suggest a modification to the predictive model; and in response to a determination that the risk of the one or more negative consequences is greater than the threshold, including an indication of whether the risk of the one or more negative consequences is greater than the threshold and a suggestion to modify the predictive model to reduce the risk of the one or more negative consequences in the analysis.

Clause 12, the computer-implemented method of clause 11, further comprising: determining, based on the risk of the one or more negative consequences, an update to the metadata of the predictive model; and updating the metadata of the predictive model to account for the risk of the one or more negative consequences.

Clause 13 a predictive model screening system, comprising: a storage medium; and one or more processors configured to: obtain a predictive model and metadata of the predictive model; determine, based on a set of criteria for screening the predictive model, a risk of one or more negative consequences associated with the predictive model; generate an analysis of the risk of the one or more negative consequences; and provide the analysis of the risk of the one or more negative consequences for display on a display screen of an electronic device.

Clause 14, the predictive model screening system of clause 13, wherein the one or more processors are further configured to periodically update the metadata of the predictive model to account for the risk of the one or more negative consequences associated with the predictive model.

Clause 15, the predictive model screening system of clauses 13 or 14, wherein the one or more processors are further configured to generate one or more empirical indicators of the risk of the one or more negative consequences, wherein the analysis comprises the one or more empirical indicators.

Clause 16, the predictive model screening system of clause 15, wherein the one or more processors are further configured to determine a number of negative feedbacks of the predictive model, wherein the number of negative feedbacks of the predictive model is an empirical indicator of the one or more empirical indicators.

Clause 17, the predictive model screening system of any of clauses 13-16, wherein the one or more processors are further configured to: determine whether the risk of the one or more negative consequences is greater than a threshold to suggest a modification to the predictive model; in response to a determination that the risk of the one or more negative consequences is greater than the threshold, include an indication of whether the risk of the one or more negative consequences is greater than the threshold and a suggestion to modify the predictive model to reduce the risk of the one or more negative consequences in the analysis; determine, based on the risk of the one or more negative consequences, an update to the metadata of the predictive model; and update the metadata of the predictive model to account for the risk of the one or more negative consequences.

Clause 18, a non-transitory computer-readable medium comprising instructions, which when executed by a processor, cause the processor to perform operations comprising: obtaining a predictive model and metadata of the predictive model; determining, based on a set of criteria for screening the predictive model, a risk of one or more negative consequences associated with the predictive model; generating one or more empirical indicators of the risk of the one or more negative consequences; generating an analysis of the risk of the one or more negative consequences, wherein the analysis comprises the one or more empirical indicators; and providing the analysis of the risk of the one or more negative consequences for display on a display screen of an electronic device.

Clause 19, the non-transitory computer-readable medium of clause 18, wherein the instruction, when executed by the processor, cause the processor to perform operations comprising: determining, based on the risk of the one or more negative consequences, an update to the metadata of the predictive model; and updating the metadata of the predictive model to account for the risk of the one or more negative consequences associated with the predictive model.

Clause 20, the non-transitory computer-readable medium of clauses 18 or 19, wherein the instruction, when executed by the processor, cause the processor to perform operations comprising: determining whether the risk of the one or more negative consequences is greater than a threshold to suggest a modification to the predictive model; and in response to a determination that the risk of the one or more negative consequences is greater than the threshold, including an indication of whether the risk of the one or more negative consequences is greater than the threshold and a suggestion to modify the predictive model to reduce the risk of the one or more negative consequences in the analysis; determining, based on the risk of the one or more negative consequences, an update to the metadata of the predictive model; and updating the metadata of the predictive model to account for the risk of the one or more negative consequences.

As used herein, the singular forms “a,” “an,” and “the” are intended to include the plural forms as well, unless the context clearly indicates otherwise. It will be further understood that the terms “comprise” and/or “comprising,” when used in this specification and/or the claims, specify the presence of stated features, steps, operations, elements, and/or components, but do not preclude the presence or addition of one or more other features, steps, operations, elements, components, and/or groups thereof. In addition, the steps and components described in the above embodiments and figures are merely illustrative and do not imply that any particular step or component is a requirement of a claimed embodiment.

What is claimed is:

1. A computer-implemented method to screen a predictive model for risks of the predictive model, comprising:
obtaining a predictive model and metadata of the predictive model;
determining, based on a set of criteria for screening the predictive model, a risk of one or more negative consequences associated with the predictive model; and
generating an analysis of the risk of one or more negative consequences.

2. The computer-implemented method of claim 1, wherein a criterion of the set of criteria is a model complexity of the predictive model, and wherein determining, based on the set of criteria for screening the metadata comprises determining, based on the model complexity of the predictive model, the risk of the one or more negative consequences.

3. The computer-implemented method of claim 1, wherein a criterion of the set of criteria is a variability of the predictive model across a plurality of stratifications, and wherein determining, based on the set of criteria for screening the metadata comprises determining, based on the variability of the predictive model across the plurality of stratifications, the risk of the one or more negative consequences.

4. The computer-implemented method of claim 1, wherein a criterion of the set of criteria is a presence of a predetermined flag associated with the predictive model, and wherein determining, based on the set of criteria for screening the metadata comprises determining, based on the predetermined flag associated with the predictive model, the risk of the one or more negative consequences.

5. The computer-implemented method of claim 1, wherein a criterion of the set of criteria is a user-defined rule associated with the predictive model, and wherein determining, based on the set of criteria for screening the metadata comprises determining, based on the user-defined rule associated with the predictive model, the risk of the one or more negative consequences.

6. The computer-implemented method of claim 1, wherein a criterion of the set of criteria is a similarity in a characteristic of interest, and wherein determining, based on the set of criteria for screening the metadata comprises determining, based on the similarity in the characteristic of interest, the risk of the one or more negative consequences.

7. The computer-implemented method of claim 1, further comprising updating the metadata of the predictive model to account for the risk of the one or more negative consequences.

8. The computer-implemented method of claim 1, further comprising generating one or more empirical indicators of the risk of the one or more negative consequences, wherein the analysis comprises the one or more empirical indicators.

9. The computer-implemented method of claim 8, further comprising determining a number of negative feedbacks of the predictive model, wherein the number of negative feedbacks of the predictive model is an empirical indicator of the one or more empirical indicators.

10. The computer-implemented method of claim 1, further comprising providing the analysis of the risk of the one or more negative consequences for display on a display screen of an electronic device.

11. The computer-implemented method of claim 1, further comprising:
determining whether the risk of the one or more negative consequences is greater than a threshold to suggest a modification to the predictive model; and
in response to a determination that the risk of the one or more negative consequences is greater than the threshold, including an indication of whether the risk of the one or more negative consequences is greater than the threshold and a suggestion to modify the predictive model to reduce the risk of the one or more negative consequences in the analysis.

12. The computer-implemented method of claim 11, further comprising:
determining, based on the risk of the one or more negative consequences, an update to the metadata of the predictive model; and
updating the metadata of the predictive model to account for the risk of the one or more negative consequences.

13. A predictive model screening system, comprising:
a storage medium; and
one or more processors configured to:
obtain a predictive model and metadata of the predictive model;
determine, based on a set of criteria for screening the predictive model, a risk of one or more negative consequences associated with the predictive model;
generate an analysis of the risk of the one or more negative consequences; and
provide the analysis of the risk of the one or more negative consequences for display on a display screen of an electronic device.

14. The predictive model screening system of claim 13, wherein the one or more processors are further configured to periodically update the metadata of the predictive model to account for the risk of the one or more negative consequences associated with the predictive model.

15. The predictive model screening system of claim 13, wherein the one or more processors are further configured to generate one or more empirical indicators of the risk of the one or more negative consequences, wherein the analysis comprises the one or more empirical indicators.

16. The predictive model screening system of claim 15, wherein the one or more processors are further configured to determine a number of negative feedbacks of the predictive model, wherein the number of negative feedbacks of the predictive model is an empirical indicator of the one or more empirical indicators.

17. The predictive model screening system of claim 13, wherein the one or more processors are further configured to:
determine whether the risk of the one or more negative consequences is greater than a threshold to suggest a modification to the predictive model;
in response to a determination that the risk of the one or more negative consequences is greater than the threshold, include an indication of whether the risk of the one or more negative consequences is greater than the threshold and a suggestion to modify the predictive model to reduce the risk of the one or more negative consequences in the analysis;
determine, based on the risk of the one or more negative consequences, an update to the metadata of the predictive model; and
update the metadata of the predictive model to account for the risk of the one or more negative consequences.

18. A non-transitory computer-readable medium comprising instructions, which when executed by a processor, cause the processor to perform operations comprising:
obtaining a predictive model and metadata of the predictive model;
determining, based on a set of criteria for screening the predictive model, a risk of one or more negative consequences associated with the predictive model;
generating one or more empirical indicators of the risk of the one or more negative consequences;
generating an analysis of the risk of the one or more negative consequences, wherein the analysis comprises the one or more empirical indicators; and
providing the analysis of the risk of the one or more negative consequences for display on a display screen of an electronic device.

19. The non-transitory computer-readable medium of claim 18, wherein the instruction, when executed by the processor, cause the processor to perform operations comprising:
determining, based on the risk of the one or more negative consequences, an update to the metadata of the predictive model; and
updating the metadata of the predictive model to account for the risk of the one or more negative consequences associated with the predictive model.

20. The non-transitory computer-readable medium of claim 18, wherein the instruction, when executed by the processor, cause the processor to perform operations comprising:
determining whether the risk of the one or more negative consequences is greater than a threshold to suggest a modification to the predictive model; and
in response to a determination that the risk of the one or more negative consequences is greater than the threshold, including an indication of whether the risk of the one or more negative consequences is greater than the threshold and a suggestion to modify the predictive model to reduce the risk of the one or more negative consequences in the analysis;
determining, based on the risk of the one or more negative consequences, an update to the metadata of the predictive model; and
updating the metadata of the predictive model to account for the risk of the one or more negative consequences.
